(19) United States
(12) Patent Application Publication
(10) Pub. No.: US 2005/0120118 A1
(43) Pub. Date: Jun. 2, 2005

(54) Novel network server for electronic mail filter benchmarking

(76) Inventor: Robert Harwell Thibadeau, Pittsburgh, PA (US)

Correspondence Address: Dr. Robert Thibadeau, 2 Queens Ct, Pittsburgh, PA, 15238, US

(21) Appl. No.: 10/724,422

(22) Filed: Dec. 1, 2003

(51) Int. Cl. G06F 15/16

(52) U.S. Cl. 709/228

(57) ABSTRACT

The benchmarking server is a method and apparatus for benchmarking electronic mail filters that requires no client software other than a conventional standard email client and a standard web client. In the preferred embodiment, the email address of the client is obtained and validated with an email transaction. This is followed by manufacturing a benchmark suite of emails that are then sent to the client. The manufacturing includes a means of obtaining different categories of email examples automatically and customizing these emails for use in benchmarking.

### REFERENCES

### References Cited

### U.S. Patent Documents

| | | | |
|---|---|---|---|
| 5377354 | December 1994 | Scannell et al. | 395/650. |
| 5619648 | April 1997 | Canale et al. | 709/206. |
| 5634005 | May 1997 | Matsuo | 709/206. |
| 5678041 | October 1997 | Baker et al. | 395/609. |
| 5696898 | December 1997 | Baker et al. | 395/187. |
| 5809242 | September 1998 | Shaw et al. | 395/200. |
| 5826022 | October 1998 | Nielsen | 709/206. |
| 5845263 | December 1998 | Camaisa et al. | 705/27. |
| 5864684 | January 1999 | Neilsen | 709/206. |
| 5870548 | February 1999 | Nielsen | 709/206. |
| 5874955 | February 1999 | Rogowitz et al. | 345/339. |
| 5889943 | March 1999 | Ji et al. | 713/201. |
| 5905863 | May 1999 | Knowles et al. | 709/206. |
| 5930479 | July 1999 | Hall | 709/238. |
| 5968117 | October 1999 | Schuetze | 709/206. |
| 5978837 | November 1999 | Foladare et al. | 709/207. |
| 5999932 | December 1999 | Paul. | |
| 5999967 | December 1999 | Sundsted | 709/206. |
| 6023700 | February 2000 | Owens et al. | 707/10. |
| 6023723 | February 2000 | McCormick et al. | 709/206. |
| 6052709 | April 2000 | Paul | 709/202. |
| 6073165 | June 2000 | Narasimhan et al. | 709/206. |
| 6112227 | August 2000 | Heiner | 709/203. |
| 6146026 | November 2000 | Ushiku | 709/207. |
| 6157630 | December 2000 | Adler et al. | 370/338. |
| 6161130 | December 2000 | Horvitz et al. | 709/206. |
| 6182118 | January 2001 | Finney et al. | 709/206. |
| 6189026 | February 2001 | Birrell et al. | 709/206. |
| 6195686 | February 2001 | Moon et al. | 709/206. |
| 6199102 | March 2001 | Cobb | 709/206. |
| 6216165 | April 2001 | Woltz et al. | 709/232. |
| 6226630 | May 2001 | Billmers | 707/3. |
| 6230156 | May 2001 | Hussey | 707/10. |
| 6314454 | November 2001 | Wang et al. | 709/206. |
| 6327610 | December 2001 | Uchida et al. | 709/206. |
| 6334140 | December 2001 | Kawamata | 709/202. |
| 6421709 | July 2002 | McCormick et al. | 709/206. |
| 6505237 | January 2003 | Beyda et al. | 709/206. |
| 6,654,787 | November 2003 | Aronson, et al. | 707/3 |

### BACKGROUND

1. Field of Invention

This invention relates to electronic mail, specifically an improved method for measuring the effectiveness of systems that filter or sort electronic mail.

2. Prior Art

Spam mail is a well-known problem for email users. There are many proposed solutions. On the policy side, there are laws, contracts, and other rules of behavior that try to restrict the mail that is permitted. Also on the policy side, there is the question of the definition of spam, which may be different for different people at different times. On the technology side, there are email filters developed using systems of determinant rules as taught in part by U.S. Pat. Nos. 5,377,354, 5,619,648, and 5,634,005, or statistical pattern recognition techniques as taught in part by U.S. Pat. Nos. 6,161,130 and 6,654,787.

However, it is well known that these solutions are imperfect. It can be reasonably argued that they will always be imperfect because spammers will ignore policy or will devise ways to bypass technical solutions as the spammers discover the technical solutions. A spammer seeking to avoid anti-spam policy masquerades his identity by falsifying the “From:” field. As a rudimentary example of a technical dodge, a rule that matches “SEX” will not match “S3X” even though the person reading this word will get the message, so the spammer titles his mail “S3X”. Since filtering spam mail is imperfect, there is a clear need to quantify the performance of the policies and technologies that are put in place. The present invention provides a unique measurement apparatus and method for measuring the effectiveness of spam elimination tools.

Measuring the effectiveness of a spam filter requires a benchmark set of emails to be sent through the spam filter for measurement. This set of emails contains at least two subsets, one containing spam mail and the other containing white mail (also called non-spam mail).

It is anticipated that this binary categorization may be refined using other categorizations including quantitative (e.g., a 1 to 10 point scale on ‘spamness’) or qualitative (e.g., different categories of spam and white mail such as ‘sex mail’ or ‘solicitation mail’).

The measurement is of the accuracy of the filter in properly categorizing the emails. There are many well-known accuracy reporting measures. The simplest, for the binary categorization case, is simply to report the number of correct detections of spam, the number of spam misses, the number of correct detections of white mail, and the number of white mails that are incorrectly categorized as spam.

It is unquestionable that with the large number of commercially available mail filters, these are tested and measured for effectiveness by their creators. However, there appear to be no instances of a measurement system that can be easily used by anyone using only a common email client and no other software.

### SUMMARY OF THE INVENTION

The present invention is a method for serving mail filtering benchmark tests to any user of a standard email client on any electronic network that supports email. It does not require any special knowledge of the standard email client, and it permits the user to perform any statistical analysis that he wishes of the effectiveness of his email filter. The server can benchmark personal email spam filters or enterprise email spam filters with equal ease. There is no software to install on the users' computers. In this way, a user may measure the effectiveness of his email filter in categorizing email including spam.

A brief description of the server is as follows: The server accepts the email of the user as a request for a benchmark test, then sends an email to the user to validate the user's request. On receipt of the validated request, the server generates a benchmark test in the form of sending custom formed emails to the user's email address. Part of the customization is a text string in the body of the emails that the user can search to determine that these are benchmark emails sent from the server. Another text string in the body of the emails allows the user to distinguish the category assigned to the email by the benchmark server. Using folders and search that is universal to all common email clients, the user can count the correct and incorrect categorizations made by his email filter and thereby measure the effectiveness of his email filter. The benchmark server also provides other tools, including a reporting environment where many users can report their results.

### DESCRIPTION OF THE DRAWING

The benchmark server and the interactions with it will now be described with reference to the drawing in FIG. 1 and FIG. 2.

FIG. 1 is a general block diagram of the apparatus of the preferred embodiment.

FIG. 2 is a general state diagram of the method of the preferred embodiment.

### DESCRIPTION OF THE PREFERRED EMBODIMENT

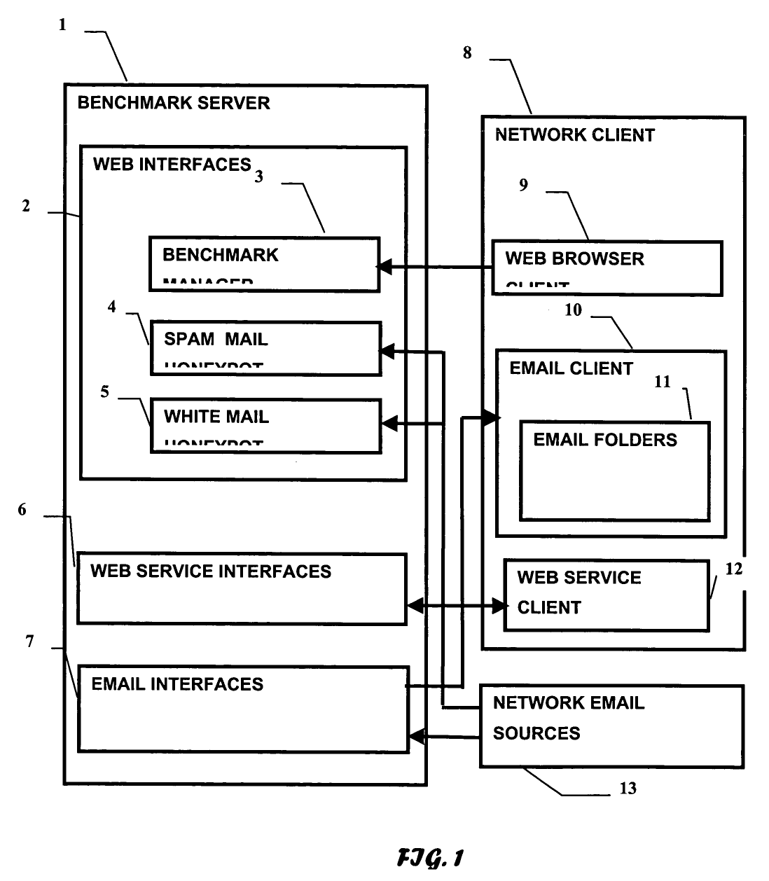

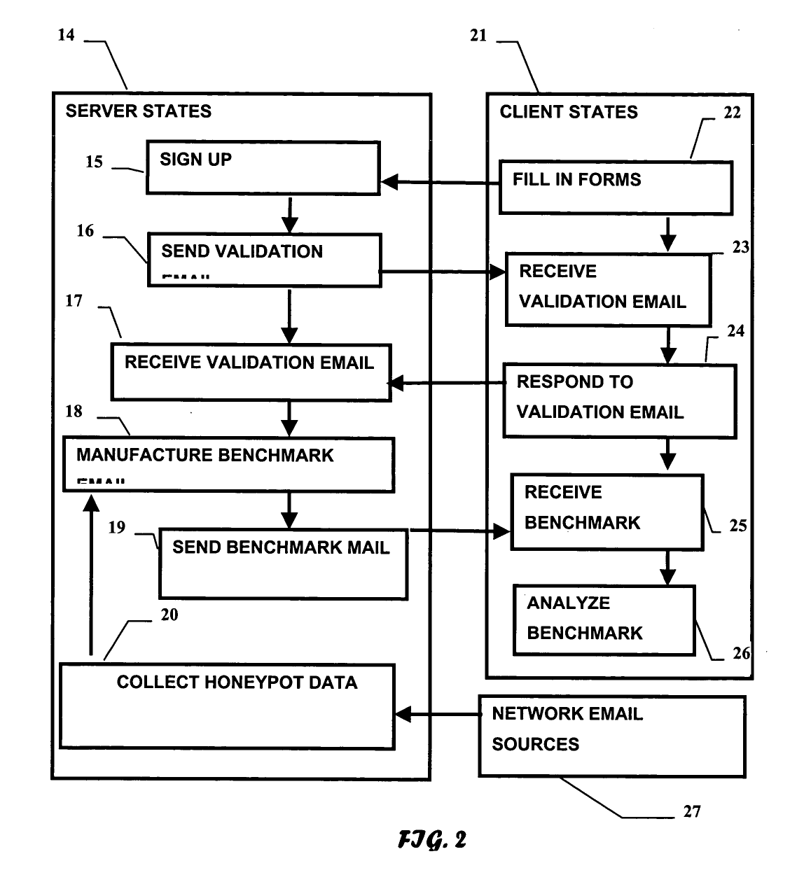

Referring to FIGS. 1 and 2, The present invention is a benchmark server 1 on an email-capable network. The server 1 may be comprised of one or more computer systems since the server achieves its functionality through the software written for it. It is anticipated that firmware or hardware may be developed to enhance the performance of A person desiring to test his email filter is the user on the network client 2. The corresponding client states 21 are shown in FIG. 2.

In 15, the benchmark server 1 presents a web site to the person at 2 as well as specific email services 7.

The user uses his web browser client 9 to go to the benchmark server web site 3 for signup 15 and fills in 22 his email address and a passcode with his request for a spam filter benchmark test.

In the preferred embodiment, this passcode in 15 and 22 may be requested to be the postal code of the user.

It is anticipated in 15 and 22 that the user may also be asked for other information (e.g., his electronic address book, examples of white mail) that may be useful in generating a benchmark suite that appears more natural.

It is further anticipated in 15 and 22 that the user may be asked to name or select the number of emails he wishes to have the benchmark server generate for the test.

It is further anticipated in 15 and 22 that this may also be a test schedule of more than one test and that the user may also submit a number of emails for a number of different copies of the same test.

It is also anticipated in 15 and 22 that the user using 21 may be asked to give evidence that he is a human tester (not a machine) or give other credentials commensurate with protecting the benchmark server against unintended use.

Once sign up is complete, the server sends a validation email 16 through 7 which is received by the client 23 through 11.

In order to avoid further malicious use of this server to create spam, the server sends the validation email 16 to the user email address 23. This email 16 is fabricated automatically by the benchmark server and contains a policy agreement that requires the user create a reply mail 24 that accepts the policy or contract and proves his acceptance and desire for the spam test by inputting the passcode he had input in 22.

In the case of having submitted multiple email addresses for testing in 22, this reply must occur for every email address that the benchmark server is asked to test.

In the case of having requested scheduled testing in 22, it is anticipated that the policy will provide a way in which the user can alter the schedule or eliminate it at a later time.

In the case where the user has named or selected the number of emails he wishes to have in 22, the benchmark server generate for the test, this number may be identified in the reply email for confirmation.

It is also anticipated that an alternative embodiment may request the user to name or select the number of test emails in the reply email 24.

Finally, the email 16 to the user contains a search key manufactured by the benchmark server. In the preferred embodiment this search key is a random number of length and style that gives the appearance of a phone number. In alternative embodiments this key may be provided using another means and may be another text string which is unique and not likely to be identified by a mail filter as relevant to a categorization decision.

The search key will later appear in clear text in every email 19 generated by the benchmark server in order to give the user in 26 a way to readily identify all the mail generated by the benchmark server.

The policy statement in 16 will provide instruction to the user on the use of this key in performing measurement of the effectiveness of his spam filter.

The instruction in 16 will also show how to identify each of the mail categories supported by the benchmark server using the category keys.

In the simplest case of a binary categorization and a key that looks like a phone number, the instruction in 16 may say that the key with a 1 at the end of the key is spam and a 0 at the end is white mail.

Upon receipt 17 of the response 24 from the user, the benchmark server 1 manufactures 18 the number of emails required.

The manufacturing process 18 is different for the different email classification categories. The manufacturing process is designed to insure that it would be infeasible for a spam filter writer to anticipate how to detect that this is benchmark test data and not real (naturally occurring) email.

The manufacturing process 18 first starts with an indefinite set of emails for each category, and then modifies these as appropriate to the user's information and the email category.

The indefinite set of emails is obtained from a stored set of emails obtained from ‘honey pot’ email addresses 20 established as part of the spam benchmark server 4 and 5.

These email addresses 20 are created to attract different kinds of email that is naturally occurring. Because it is desirable to hide their nature, these honey pot email addresses may well be distributed across different computers at different geographical locations and with different domain names and IP addresses and these may optionally relay mail to identified secret mail addresses on the benchmark server.

A spam honey pot is as simple as putting an email address in plain text on a public web page 4.

A white mail honey pot may be an email address that is published to a number of other web sites operated by network email sources 13 ‘opting in’ for solicitations.

Another natural white mail source would be a contact web page 5 that is public but that does not disclose the email address of the recipient of the mail contact.

A more refined white mail honey pot 5 that avoids and identifies spam generated by giving away email addresses would have one email address in 7 for every opted in solicitation.

Email 13 sent to the address 7 can then discriminate whether the email coming to it was from the solicited source or not.

It is anticipated that the benchmark set 18 may also be constructed by buffering inputs from trusted individual contributors or judges. Another web interface 2 or email interface 7 would provide the place where these contributors could post their contributions.

It is anticipated that if the natural email sources 4 and 5 produce new naturally occurring emails too slowly that the benchmark server may make random historical selections including only a subset of newly occurring emails.

The manufacturing of the benchmark suite 18 also involves customization. The customization of the emails for a particular spam testing request minimally involve changing the To: address of the email to the user, and changing the date and time of sending.

Other modifications in 18 may involve masking personally identifiable information in white mail. For attachments, particularly ones that may contain active components, these may be ‘neutralized’ by byte or character replacement while retaining the apparent attachments.

The benchmark set manufactured in 18 for the user is also submitted to a suite of standard spam filters for which spam performance is known to the benchmark server. If the suite fails to perform within tolerance set for the normalization suite, a new benchmark suite is manufactured. It is anticipated that this tolerance test may be skipped in some embodiments.

The user will be informed either by additional email, web services, or returning to the benchmark server web site, of the normalization results of his spam benchmark.

These normalization results are the measurements from the standard spam filters and a description of the mean and standard deviation, and possibly other statistics, for how these spam filters behaved on previous benchmark sets for previous users.

Finally, the benchmark server sends the emails 19 through 7 to the user 25 to the client's email interface 10.

At this point the user will analyze 26 his mail filter against the benchmark. He will do this by searching on the keys and counting the files moved by the mail filter to the folders 11 of the email client 10. As one example, he may have a spam folder and an inbox folder. The spam folder should get all the benchmark mail that is marked as spam and the inbox folder should get all the other benchmark mail. After the benchmark test, the user can then also easily search on the key, find all the benchmark mail, and delete it.

It is anticipated that the benchmark server may optionally additionally provide another web page (or other web services) where the user may download analysis software for his test or may report the results of his spam filter on the benchmark back to the web site or the operators and owners of the benchmark server.

It is anticipated in an alternative embodiment that the server 1 may alternatively or additionally offer web services 6, such as XML web services or other electronic data interchange for use by web services clients 12 and achieve any or all of the communications between 1 and 8 shown in FIG. 1 as defined for 14 and 21 shown in FIG. 2.

1. A method of benchmarking electronic mail (i.e., email) filtering performance, comprising the steps:
a. obtaining an email address to be tested
b. validating the email address to be tested
c. manufacturing the benchmark test suite of emails
d. electronically mailing the test suite to the tested email address

2. The method of claim 1, further including the step
a. collecting emails to be used in the benchmark suite

3. The method of claim 1, further including the step
a. customizing emails to be used in the benchmark suite

4. The method of claim 1, further including the step
a. testing the benchmark suite for normalizing against prior suites

5. The method of claim 1, that obtains an email address to be tested and further includes this step
a. obtaining a passcode for validation

6. The method of claim 1, that obtains an email address to be tested and further includes in this step
a. obtaining other user data that may be relevant to manufacturing the benchmark suite.

7. The method of claim 1, further including the step
a. the presentation of other information relevant to how the user can analyze the benchmark data.

8. The method of claim 2, further including the step
a. the collecting emails for benchmarking using a means that can reliably distinguish among categories of email automatically

9. The method of claim 3, further including the step
a. inserting a text string in the body of the benchmark emails that permits different email categories to be reliably sorted for analysis of the performance of the email filter.
